(19) United States
(12) Patent Application Publication
(10) Pub. No.: US 2016/0098732 A1
(43) Pub. Date: Apr. 7, 2016

(54) Handling Data from Online Retail Transactions

(71) Applicant: ePossibilities Limited, Reading (GB)

(72) Inventors: Daniel Burton, Reading (GB); Christopher Thomas, Reading (GB)

(21) Appl. No.: 14/507,810

(22) Filed: Oct. 6, 2014

(51) Int. Cl. G06Q 30/02

(52) U.S. Cl. CPC G06Q 30/0201

(57) ABSTRACT

There are disclosed methods and apparatus for operating a panel of online consumers. A redirection email address is generated and provided to a retailer computer system in substitution for a consumer email address. As part of an online transaction, the retailer forwards a purchase record to the consumer, but uses the redirection email address. A researcher computer system which is the addressee of the redirection email address is therefore able to intercept the purchase record for analysis, and pass the purchase record on to the consumer.

Described embodiments relate to obtaining data relating to online retail transactions, that is, information about purchases made by a consumer using a network connection to an online retailer.

### BACKGROUND

Researching and monitoring the purchase habits and activities of consumers can be useful for a variety of reasons. With the resulting information, retailers can refine ordering and stocking decisions to reduce waste and transportation inefficiencies, and manufacturers can better match capacity and component/raw material supply to expected demand. Retail offerings can also be more efficiently targeted for example using store positioning, advertising and pricing strategies. The retail offerings and activities of competitors can also be monitored and analysed.

Technical processes which may be used to gather retail information can vary widely, but typically a store can use sales data from checkout scanners to monitor purchases made by time and date and grouping of products in a single sale, and can refine this by linking a customer to a particular sale for example using a loyalty card system. Such schemes have advantages of avoiding any extra effort being required by the consumer in respect of particular purchases.

For a research organisation separate or independent from a store or a particular retailer to gather purchase information is generally more difficult, but one solution is to ask consumers to manually record each purchase, for example by writing entries on a sheet of paper or typing into an electronic document. The effort required by the consumer can be reduced by providing the consumer with a barcode scanning device which is to be used in the home to scan all purchases made, and for the scanned barcode information to be uploaded digitally to a server belonging to the research organisation.

For purchases made online (typically by a consumer using a home computer, smart phone, tablet or similar device connecting over the Internet to a retailer website), similar manual scanning schemes can be used.

### SUMMARY

Accordingly, the described embodiments enable a third party to automatically monitor online purchases made by a consumer, by providing a redirection email address to an online retailer in place of an email address of the consumer, such that purchase information sent out by the online retailer is initially received by the addressee of the redirection email address instead of at the consumer email address, and then automatically forwarding the purchase information to the consumer email address.

In this way, a panel of such online consumers can be assembled and organised such that their purchases can be automatically and efficiently monitored for subsequent analysis, while minimising the amount of effort required of those consumers. In practice, following an initial set up stage in which a redirection email address is provided by a researcher server or similar, and a step of providing this in an appropriate way to retailer servers, the monitoring process may be invisible or largely invisible to the consumers of the online panel. In fact, in order to remind consumers of their participation from time to time, the researcher server may add a message to the purchase data to this effect. A panel of online consumers may comprise a small or large number of such consumers, for example ranging from tens to tens of thousands of such consumers.

These activities may typically be carried out by a researcher organisation or entity, and will typically be carried out automatically by a computer system or server of such an organisation, with reference to a computer system or server of the retailer, and a computer system or one or more computer devices of the consumer.

The described embodiments therefore provide, more specifically, a method of operating a researcher computer system to obtain data identifying purchases made online by a consumer having a consumer email address, the method comprising: providing a redirection email address for provision to a retailer computer system, the researcher computer system being the addressee of emails sent to the redirection email address; receiving a purchase record, sent from the retailer computer system to the redirection email address, the purchase record recording purchases made by the consumer on line using the retailer computer system; forwarding at least some of the content of the purchase record to the consumer email address for receipt by the consumer; and extracting data relating to the purchases from the purchase record.

The redirection email address is provided to the retailer in the place of or instead of or in substitution for the consumer email address, such that the retailer treats the redirection email address as the address to which a purchase record is to be sent when a consumer completes a transaction. Typically, the consumer will not be an addressee of the redirection email address, but the retailer will typically not be aware of this. Typically also, the consumer may have previously registered the consumer email address with the retailer, and then subsequently registers the redirection email address at the retailer in place of or in substitution of the consumer email address.

Typically, the consumer computer system, the researcher computer system, and the retailer computer system may all reside in different Internet domains. Similarly, the redirection email address and the consumer email addresses will typically have different Internet domain parts.

The researcher computer system may automatically generate the redirection email address, and/or may store a plurality of suitable redirection email addresses for future use. Typically, the researcher computer system may transmit the redirection email address to the consumer for the consumer to forward on to the retailer, but the researcher computer system may instead automatically provide the redirection email address to the retailer directly, without intervention of the consumer.

The redirection email address may be unique to the consumer, and a different such unique email address could be used in respect of each of a plurality of retailers with which a particular consumer conducts purchase transactions, thereby assisting the researcher computer system in accurately identifying, organizing and analysing each purchase record through recognizing the email address to which it is addressed by a retailer.

Extracting data relating to the purchases from the purchase records may comprise the researcher computer system parsing the purchase record to extract required fields.

Various embodiments also encompass activities and/or apparatus of one or more consumers or consumer computer systems, for example a consumer computer system receiving the redirection email address from the researcher computer system and forwarding the received redirection email address to the retailer computer system, and/or the consumer using a consumer computer system to make said purchases over a network connection to the retailer computer system, the consumer computer system being an addressee of emails directed to said consumer email address. Typically, some time before forwarding the received redirection email address to the retailer computer system, the consumer may have forwarded the consumer email address to the retail consumer system for use in communications and transactions between the consumer and the retailer, such that subsequent forwarding of the received redirection email address to the retailer computer system replaces the consumer email address at the retailer computer system. The retailer may have been using the consumer email address to send emails including purchase records to the consumer for an extended period, for example more than a month, before the redirection email address is substituted for the consumer email address at the retailer computer system.

A consumer computer system may comprise one or more different computing devices used from time to time by a consumer, for example a desktop computer, a smartphone and a tablet computer, and these devices might be used for different parts of the method. For example, a tablet computer might be used for transacting retailers, and a desktop computer for sending and receiving emails according to the methods described herein. Typically, at least one such device may be configured to act as an endpoint for receipt of emails addressed to the consumer email address.

Various embodiments may also encompass activities and/or apparatus of one or more retailers or retailer computer systems, for example by way of a retailer computer system receiving the redirection email address in place of the consumer email address, generating said purchase record in response to online purchases made by the consumer, and emailing the purchase record to the redirection email address.

Embodiments also include apparatuses corresponding to the above methods, such as a researcher computer system for automatically obtaining data identifying purchases made online purchases made by a customer having a consumer email address, the computer system being adapted to: provide a redirection email address for provision to a retailer computer system in place of or substitution for the consumer email address, the researcher computer system being the addressee of emails sent to the redirection email address; receive a purchase record, sent from the retailer computer system to the redirection email address, the purchase record recording purchases made by the consumer online using the retailer computer system; and forward at least some of the content of the purchase record to the consumer email address for receipt by the consumer. Such a computer system may also be arranged to extract data relating to the purchases from the purchase record, to analyse such data for example using a suitable analysis component, and to produce reports generated from such data and analysis. Such analysis may comprise combining extracted data from a plurality of purchase records, and/or in respect of a plurality of consumers, and/or in respect of a plurality of retailers.

The researcher computer system may further comprise an email address generator for generating the redirection email address for provision to the retailer computer system, and may further comprise a researcher computer system graphical user interface GUI for presentation on a web browser of the consumer to permit registration of the consumer with the researcher computer system. Such a GUI may be arranged to receive from the consumer the consumer email address and to provide to the consumer the redirection email address.

Described embodiments also include computer program products stored on non-transitory computer-readable media and including instructions for causing a computer to execute the various methods described here. Such a computer system may be a researcher computer system as discussed above, having one or more processors and memory for storing and the computer program code and facilitating operation of the processor(s) in this respect.

Where a computer server, device or system is referred to herein, such a server, device or system typically comprises memory for storing data and program code, at least one processor for executing said program code including to process said data, and network connectivity in order to provide communications to other servers, devices or systems as described herein as well as to other servers, devices or systems as maybe required to effect control and management. At least the consumer computer devices mentioned herein will also typically be provided with suitable input and output arrangements for direct use by the consumer, such as one or more of a computer mouse, keyboard, touch screen, other visual display arrangements, and so forth.

### BRIEF DESCRIPTION OF THE DRAWINGS

Embodiments of the invention will now be described, by way of example only, with reference to the drawings of which:

FIG. 1 illustrates an embodiment of the invention, in terms of the entities involved, their interconnectivity, and the passing of the consumer email address, the redirection email address, and the purchase record between these entities;

FIG. 2 shows steps of a method embodying the invention;

FIG. 3 is similar to FIG. 1 but providing more detail in respect of apparatus elements which may be provided for putting embodiments of the invention into effect; and

FIG. 4 shows an exemplary purchase record.

### DETAILED DESCRIPTION OF EMBODIMENTS

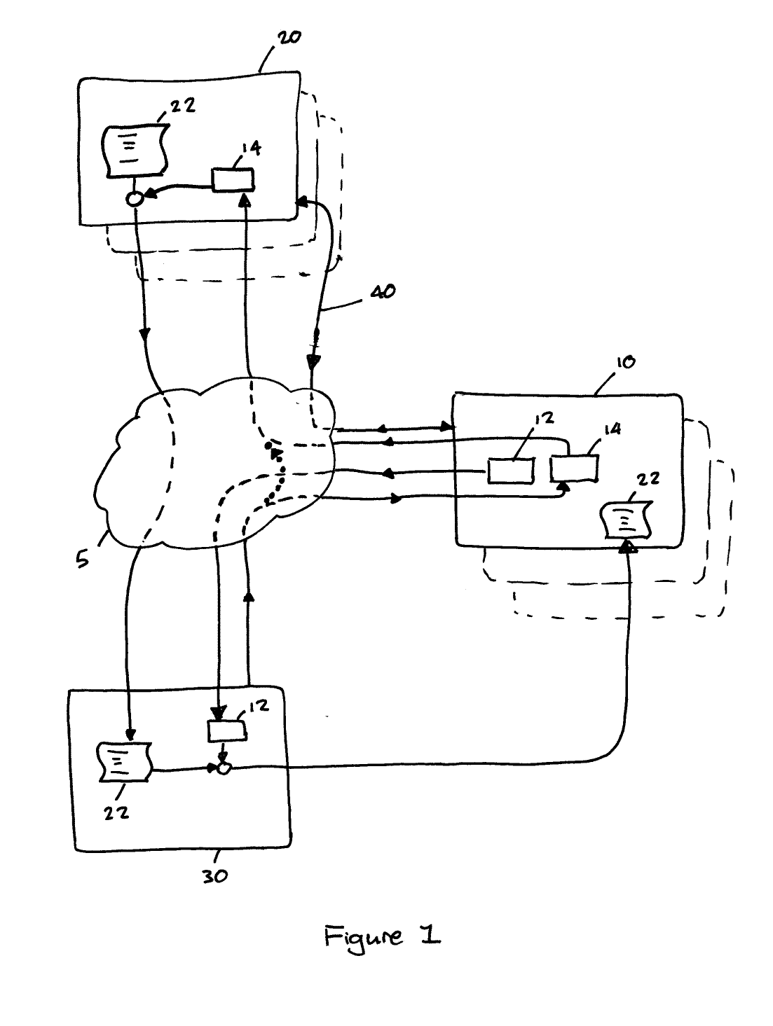

Referring now to FIG. 1 there is illustrated schematically a scheme for automatically obtaining data identifying purchases made on line by a consumer 10 over a network connection to a retailer 20, typically implemented as a retailer server. The retailer could be selling various different kinds of goods and/or services, but typically these might include one or more of groceries, electrical goods, clothing, insurance, digital media downloads, and so forth.

Under normal circumstances, the consumer 10 would provide the retailer 20 with the consumer's email address 12, so that information relating to purchases made, for example as part of a purchase transaction 40 between the consumer 10 and the retailer 20, can be emailed from the retailer 20 to the consumer 10. However, in the present scheme, the consumer is provided with a redirection email address 14, and as part of the online relationship between the consumer 10 and the retailer 20, the consumer provides the redirection email address 14 to the retailer 20 under circumstances which cause the retailer to assume that the redirection email address 14 is the normal email address of the consumer (for example the consumer email address 12).

Frequently, the consumer may have previously provided the consumer email address to the retailer, and then according to the invention subsequently provides the redirection email address in replacement of or substitution for the consumer email address. The retailer may have been using the consumer email address to send emails to the consumer for an extended period, for example for several weeks, months or even years, before the redirection email address is substituted for the consumer email address at the retailer computer system.

The addressee of the redirection email address 14 is actually a researcher entity 30, typically implemented using one or more researcher servers, and this redirection email address may be generated and/or provided to the consumer 10 by the researcher 30. The researcher 30 is also provided with the consumer email address 12, for example by the consumer 10. This exchange of email addresses between the consumer 10 and researcher 30 may take place in a set up transaction 40 conducted between the consumer 10 and the researcher 30.

When the retailer 20 reaches a step of automatically sending a purchase record 22 to the consumer containing data relating to purchases made by the consumer as part of the purchase transaction 40, this is sent by the retailer to the email address most recently provided by the consumer 10 for this purpose, which is now the redirection email address 14. The purchase record 22 is therefore automatically delivered by email directly to the researcher 30 instead of the consumer, where it may be automatically analysed to derive information about the purchases and to carry out further researcher activity for example by consolidating purchase data from multiple purchase transactions and/or multiple consumers, deriving trends and summaries, and the like, for example as described in more detail below. The purchase record 22 is then emailed automatically by the researcher 30 to the consumer 10 using the consumer email address 12, optionally after amendment of the purchase record of some kind.

Using this scheme, following an initial set up transaction in which the redirection email address 14 is provided to the consumer 10 for passing on to the retailer 20, and in which the consumer email address 14 is passed to the researcher 30, the consumer 10 can make on line purchases at the retailer and receive the purchase records 14 transparently and without further effort, while the researcher 30 also automatically receives the purchase records for analysis. Other emails sent by the retailer 20 to the consumer 10 using the redirection email address 14, which are not purchase record emails, may also be automatically forwarded on to the consumer 10 by the researcher 30, with or without associated analysis of such emails at the researcher 30. These could include messages relating to the maintenance of the customer's account with the retailer, marketing material, and so forth.

FIG. 1 shows the various communications and transactions outlined above being transmitted through a network 5, which may typically be the Internet. The consumer 10 will typically also use this network to communicate electronically with the retailer 20 in order to transact the purchases represented by the purchase record 22. Note that the purchase record 22 may represent purchases already made and/or purchases which are only partially completed or not yet legally finalised, for example for which payment and/or delivery of related goods and/or services is still pending.

The consumer 10 of FIG. 1 may represent or be implemented by a computer system used by a consumer person, which may comprise one or more individual computer devices used by a particular consumer person. For example, the consumer person may use a single smart phone, tablet, laptop or desktop personal computer device to exchange the consumer email 12 and redirection email 14 with the researcher 30, communication with the retailer 20 including to make purchases over the network 5, and to receive the purchase record 22, or may use multiple different devices for one or more of these steps. Any such devices may then be considered to be comprised in the consumer computer system.

Similarly, each of the retailer 20 and the researcher 30 may be implemented using a retailer computer system and a researcher computer system which may each comprise a single or multiple server and/or other computer entities. For simplicity, the entities responsible for handling and routing emails and other communications over the network such as email clients, servers, Internet addressing and routing infrastructure, and similar, are not shown in FIG. 1, but will be familiar to the person skilled in the art.

FIG. 1 also illustrates how the scheme may be implemented such that a researcher 30 automatically acquires purchase records from transactions made by various different consumers 10 with various different retailers 20. To achieve this, each consumer 10 need only by provided with one redirection email address 14 for use with all of the retailers. In particular, each consumer may be associated with a unique redirection email address. It is also possible for the researcher to provide a different redirection email address 14 for a consumer to use with each retailer or each of a different group or class of retailer. Using these arrangements and techniques a panel of online consumers can be recruited and managed such that their participation in the panel is largely transparent to the consumers once the redirection emails have been set up with the retailers.

Email addresses as discussed herein are typically in the standard format of username@example.com or similar, where the username is a local part and the example.org is an email domain part. An email server may use the Domain Name System (DNS) to locate a destination email server for domain by querying for mail exchanger (MX) records. A mail exchanger entity does not need to be actually located in the domain but needs to accept email addressed to the domain. In embodiments of the present invention, the consumer email address and the redirection email address will typically have different domain parts, because the consumer and the researcher will typically not be related for the purposes of Internet addressing. Similarly, the retailer will typically operate in another, third Internet domain, and send emails having a sender address which has a domain different to those of the consumer and redirection email addresses.

Redirection email addresses for use with the invention may be generated at, or provided at or by the researcher 30, or at or by another entity or computer system. A redirection email address for use by a particular consumer 10 could be generated from the consumer email address by making predetermined and/or randomised changes. Generally, in generating a redirection email address, the domain part of the redirection email address will be formed of or changed to a domain associated with or under control of or registered to the researcher. The researcher could acquire or use multiple domains specifically selected for, or suitable for, this use, and use different such domains for different users, different groups of users, or for different retailers or groups of retailers.

It may be desirable to reduce the visibility of the redirection scheme of the invention to retailers 20, and this may be achieved by using a wide range of different domains across the range of redirection email addresses being used by the scheme, for example between around 10 and 100 different domains. The availability of multiple domains may also be used where two consumers have consumer email addresses with the same user name, in which case the corresponding redirection email addresses could still use the same user names but different domains.

The user name part of the consumer email address could be retained for use as the user name part of the redirection email address for a consumer, or could be modified slightly, or changed completely. Minor modifications could be made, for example, by adding a prefix and/or a suffix of one or more characters to the user name. Alternatively, a user name part of a redirection email address could be completely unrelated to the user name part of the corresponding consumer email address.

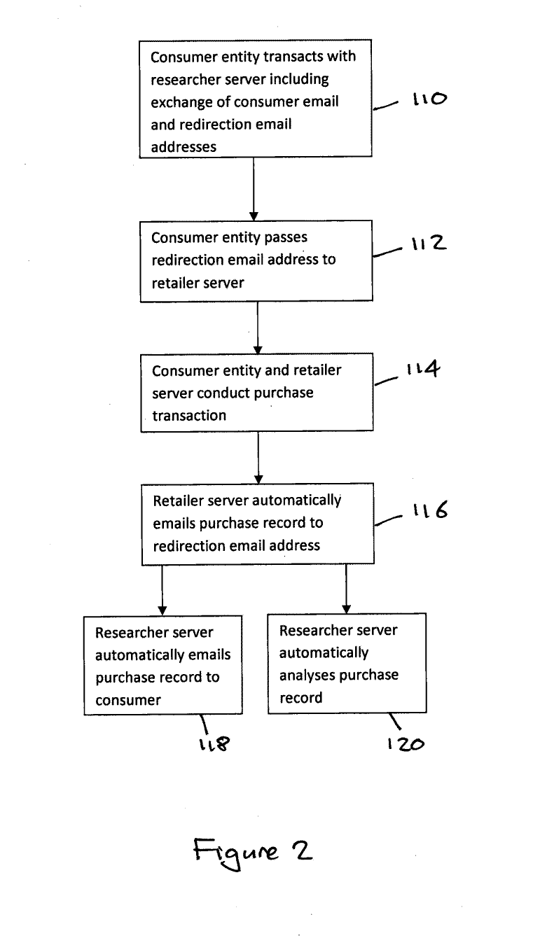

FIG. 2 illustrates in general terms method steps which may be carried out in putting into effect the scheme illustrated in FIG. 1. In the first step 110 of the figure, the consumer 10 transacts with a researcher 30 or researcher server to trigger participate of the consumer 30 on the scheme. This involves the researcher server automatically sending the redirection email address 14 to the consumer 10, for example as part of a set up transaction with the consumer, and the consumer sending the consumer email address 12 to the researcher server. This step may also involve the researcher server generating a suitable redirection email address 14, or recovering a suitable earlier generated email address from storage. From the consumer's perspective, this step may be carried out using a graphical user interface such as one or more interactive web pages served by the researcher 30 to a web browser executing at the consumer 10.

In the subsequent, second step 112 of FIG. 2, the consumer passes the redirection email address 14 to the retailer 20 or retailer server. This may be achieved as part of a registration or account management process between the consumer 10 and the retailer server, for example using one or more interactive web pages served from the retailer server to the consumer 30. Alternatively, the researcher server may pass the redirection email 14 directly to the retailer server. This could be achieved by the researcher server having acquired sufficient account details from the consumer for the researcher server to act in place of the consumer 20 as part of the above registration of account management process.

Subsequently, during a third step 114 of FIG. 2 the consumer 10 conducts a purchase transaction 40 with the retailer, for example using one or more interactive web pages served by the retailer server to a web browser at the consumer over the network 5. As part of this transaction the consumer makes one or more purchases from the retailer. As part of the purchase transaction, the retailer server automatically generates the purchase record 22. This may be carried out when the transaction has been completed, or if appropriate during the transaction or at some other time. The purchase record identifies one or more purchases made as part of the purchase transaction, for example providing data such as an item purchased, a quantity of the item(s) purchased, a price of the item(s), and similar.

When the purchase record 22 has been generated it is automatically emailed at step 116 by the retailer server to the email address held by the retailer server for such purposes, which is now the redirection email address 14 and not the consumer email address 12. The purchase record 22 is therefore received by the researcher server, which automatically conducts the two steps subsequently shown in FIG. 2 on this basis. A first of these steps 118 is for the researcher server to forward the purchase record 22 on to the consumer using the consumer email address 12. A second of these steps 120 is for the researcher server to analyse the purchase record 22. As noted elsewhere herein, the purchase record 22 may be forwarded to the consumer unaltered or in an altered or amended form. For example, a visible flag or note could be added to the purchase record 22 before forwarding to the consumer to remind the consumer that the purchase record has been received and processed by the researcher 30.

Noting that the researcher entity 30 may typically be implemented using one or more computer servers or other arrangement of a researcher computer system, the steps described in FIG. 2 and elsewhere as carried out by the researcher or researcher computer system may typically be carried out automatically, by execution of suitable software provided as part of the researcher computer system. This automatic operation includes, for example, (i) the initial transactions to obtain the consumer email address and to deliver the redirection email address either to the consumer or to the retailer; (ii) subsequent receipt and analysis of a purchase record 22 from the retailer; and (iii) forwarding of the purchase record 22 on to the consumer.

Emails sent out by the retailer to the consumer may include various further emails in addition to purchase record emails, for example including advertisements and marketing messages of various kinds, surveys, reports of online activity by the consumer with the retailer, information relating to products in which the consumer has registered an interest (for example by placing on a watch list, in an online basket, saved for later list, or similar). Because the retailer may also direct these further emails to the redirection email address registered at the retailer for a particular consumer, the researcher is preferably arranged to forward any such further emails received from the retailer on to the consumer. However, the researcher may also be arranged to automatically detect and analyse such further emails to obtain further intelligence about the activities of retailers and consumers, such as marketing activity data and related response data. For example, using detection and analysis of these further emails the researcher may be able to generate data relating to promotional campaigns and similar activities of the retailer, and output this data in the form of one or more reports.

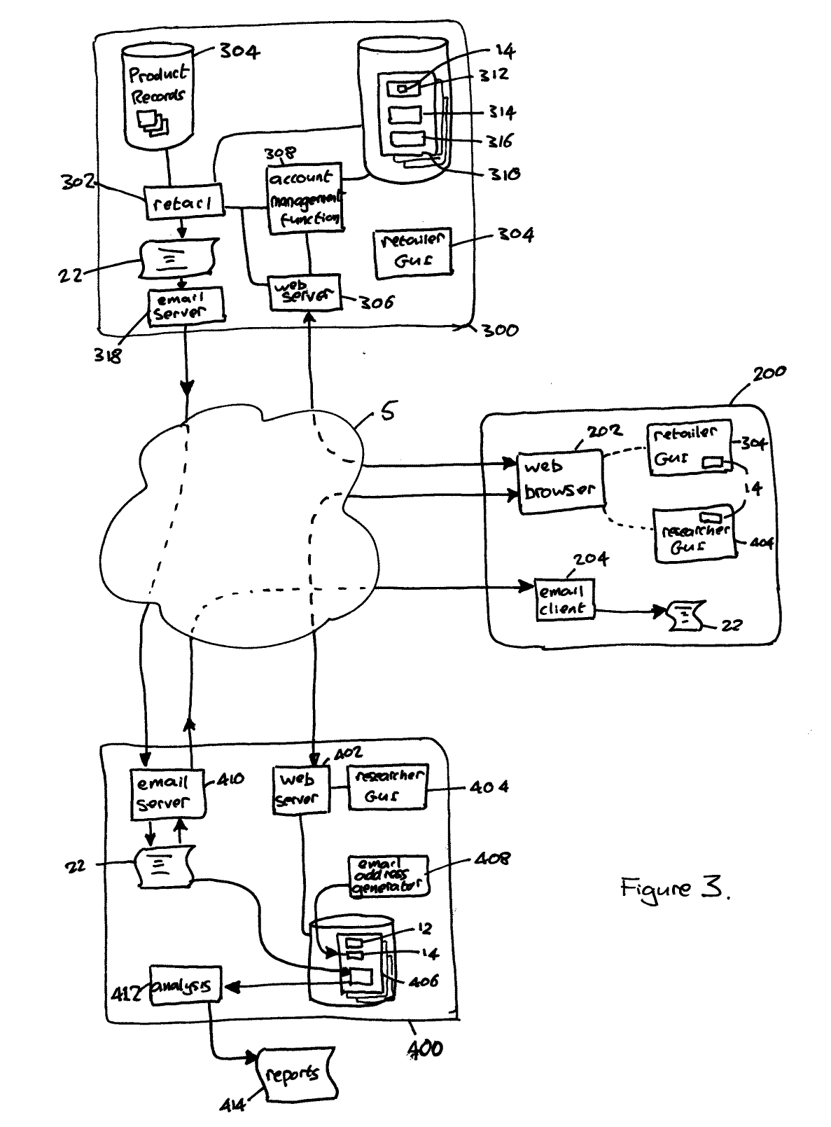

Referring now to FIG. 3, there is shown schematically an arrangement of computer systems for putting into effect the scheme of FIGS. 1 and 2. In particular, the consumer 10 of FIG. 1 is implemented using a consumer computer system 200, the retailer 20 of FIG. 1 is implemented using a retailer computer system 300, and the researcher 30 of FIG. 1 is implemented using a researcher computer system 400. Each of the retailer and researcher computer systems will typically be made up of one or more server computers arranged to communicate with each other, and to communicate with outside entities over the Internet 5. As mentioned above, the consumer computer system 200 may comprise one or more smart phones, tablet computers, desk top computers and similar computing devices which a particular consumer uses to carry out Internet browsing, online shopping, and email operations, for example including receiving emails directed to the consumer email address 12. Each such server and computing device is provided in the usual way with suitable microprocessor, volatile memory, long term memory, input and output, and network connectivity facilities in order to fulfil its expected functions.

Referring to the detail of FIG. 3, the researcher computer system 400 comprises a web server 402 which is used to present a researcher graphical user interface (GUI) 404 to a consumer computer system 200. As part of a set up transaction with the consumer computer system 200, a consumer data record 406 may be set up or modified at the researcher computer system to contain details such as a consumer name, address, contact details such as the consumer email address 12. As part of the set up transaction the redirection email address 14 may also be generated by email address generator function 408, stored in the consumer data record 406, and passed to the consumer computer system 200 using the researcher GUI 404. The consumer data record 406 for a particular consumer may also contain a copy of each, or at least some of the purchase records 22 which are received, over a period of time after the set up transaction, by the researcher computer system 400 in respect of that consumer.

In order to participate in the set up transaction, the consumer computer system 200 comprises a web browser 202 which operates to present the researcher GUI 404 to a consumer. The redirection email address 14 may be received by the consumer computer system 200 through the researcher GUI.

The retailer computer system 300 includes a retail function 302 which is arranged to retail to consumers a plurality of products (which may comprise or include services of various kinds) detailed in product data records 304. A consumer is able to use this retail function to make purchases by interacting with a retailer GUI 304 served by a web server 306 of the retailer computer system 300, using the web browser client 202 at the consumer computer system.

The retailer computer system 300 also comprises an account management function 308, which manages consumer records 310 containing for example details about a consumer account including one or more email addresses 312 for use in communicating with the relevant consumer, payment and delivery details 314, and history of previous purchases 316. A consumer is also able to update aspects of the consumer account such as one or more of the email addresses 312 using the retailer GUI. In particular, having received a redirection email address 14 through the researcher GUI 404, a consumer can pass this redirection email address 14 on to the retailer computer system using the retailer GUI 304, as if it was the consumers regular email address, and without the retailer needing to know otherwise.

Note that a consumer record 310 at a retailer computer system 300 may comprise more than one email address in respect of a particular consumer. For example, the consumer maybe able to specify different email addresses for different purposes. In such a case the email address used by the retailer computer system 300 for forwarding the purchase record 22 to the consumer should be set to be the redirection email address.

As an alternative already mentioned above (but not shown in FIG. 3), the researcher computer system 400 may provide the redirection email address 14 directly to the retailer computer system 300, for example by direct transaction with the retailer web server 306 using relevant account details of the consumer in order to appear to be the consumer, or perhaps by way of an agreement and corresponding transaction directly between the researcher and retailer.

As part of a purchase transaction 40 between the customer computer system 200 and the retailer computer system 300, the retail function 302 generates a purchase record 22, and passes this to an email server 318 of the retailer computer system for forwarding to the relevant consumer. According to the present invention, however, the email address held by the retailer computer system for this purpose is the redirection email address 14 for which the researcher computer system 400 is the addressee. The purchase record 22 is therefore delivered by email to an email server 410 at the researcher computer system 400, typically for storage in the relevant consumer data record 406. The purchase record 22 and other purchase records received in respect of the same and/or other consumers, and the same and/or other retailers, may be analysed by an analysis function 412 of the researcher computer system 400 to yield one or more reports 414 or other relevant output.

The purchase record 22 received at the researcher computer system 400 is also emailed, in the original or a modified form, to the consumer using the consumer email address 12 held in the consumer data record 406, to be received by an email client 204 at the consumer computer system 200. It would be usual for the consumer computer system to receive emails directed to the consumer email address 12 through an email server hosted by an Internet Service Provider organisation or similar, although for simplicity no such hosting email server is shown in FIG. 3.

FIG. 3 shows how the invention may be put into effect using various computer systems in general terms, but more specifically, the retailer computer system 300 may typically be implemented using a plurality of servers located at a server farm and operated by the retailer or a third party, or at a premises of the retailer. Such servers may implement the database functionality required for the product and consumer records, the web server functionality, the retailer GUI, and the retail and account management functionality using software tools familiar to the skilled person. Similarly, the researcher computer system may be implemented using a plurality of servers located at a premises of the researcher or another organisation operating the researcher computer system 400, at a third party site, and so forth, and make use of similar database, web server, GUI and process control software.

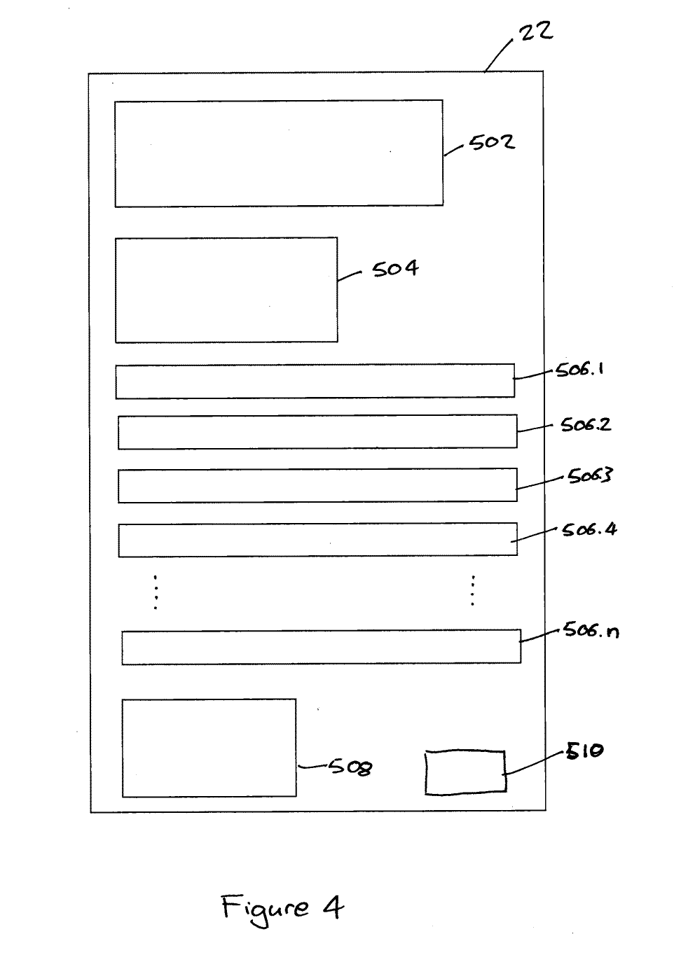

FIG. 4 illustrates some elements of a typical purchase record 22 which may be generated by a retailer computer system 300 and, according to the embodiments of the invention, sent to the redirection email address 14. The purchase record 22 of FIG. 4 is formed of a consumer readable document containing text and optionally graphics, for example in HTML or other suitable format suitable for sending by email. The purchase record could be provided as part of in line email text, in an encoded format, as an attachment, etc. Typical formats for an attachment may include Adobe PDF, Microsoft Word, etc. The analysis function 412 shown in FIG. 3 is adapted to be able to parse and analyse any such purchase record formats as required in a particular system.

The purchase record 22 of FIG. 4 contains at least: order data 502, payment data 504, data describing one or more purchases 506.1-506.n, and retailer data 508. The order data 502 may for example provide an order reference number, name or other identification of the consumer, a delivery address, a delivery date and time, and so forth. The payment data 504 may contain a total monetary payment amount, tax details, payment mechanism, billing address and similar. The data describing each purchase 506.1-506.n may contain text identifying or describing the item(s) of that purchase, a product identity code, a number of the item purchased and a total cost for that purchase. The retailer data 508 may include aspects such as the retailer name, address, telephone number, email and other contact details.

The researcher computer system 400 may add an additional field or message 510 to the purchase record 22 before sending the purchase record on to the consumer, for example a message reminding the consumer that the purchase record has been processed by the researcher computer system, adding a benefit message of some kind such as a redeemable voucher code, and/or informing the consumer of the current state of a benefit accrued by the consumer with the researcher for participating in the consumer panel program.

Further information about the purchase record 22 may be derived by the researcher computer system from metadata associated with the email, for example a sender email address (which would typically be an email address of the retailer 20), a subject line, and a time stamp of when the email was sent. These and similar data elements may also be considered to form a part of the purchase record 22.

The analysis function 412 of the retailer computer system may operate in various ways in order to analyse one or more purchase records 22 received from one or more retailer computer systems 200 in respect of purchase transactions completed by one or more customer computer systems 100. Typically, it will be necessary for the analysis function 412 to parse the purchase record 22 in some way, to extract fields and data of interest, for example by prior knowledge of expected locations, contextual data, format and content of the relevant fields. The purchase records delivered by email by any one retailer will typically differ in content and structure to those delivered by another retailer, so the analysis function 412 will typically be equipped to parse purchase records in these different formats, for example being explicitly programmed to handle purchase records from some retailers, and to ignore others as being outside the scope of the parsing function 412.

Having parsed a purchase record 22 to identify and isolate relevant data such as products and prices, various further analysis may be carried out for subsequent reporting in some way. By way of some examples, the analysis function 412 could provide statistics showing the variations in price and time and across different retailers of a particular product, the frequency with which a particular product is bought as a function of time, geography, and other factors. The analysis function could similarly derive purchase behaviour data, for example across all or for particular groups or classes of consumers and/or retailers and/or products. This may be used to generate data indicating effectiveness of or response to promotional activity, and to detect short term or longer term changes in consumer activity, either generally or in response to events or circumstances such as economic, social or environmental conditions, entertainment schedules and similar.

Various modifications may be made to the described embodiments without departing from the spirit and scope of the invention, which is defined by the appended claims. For example, although in the detailed embodiments the purchase record is forwarded from the retailer to the researcher and from there on to the consumer by email, other modes of electronic data transmission could be used as well or instead of email, such as instant messaging, SMS, drop box arrangements and so forth, with the retailer 20 being provided with a corresponding suitable redirection address which provides appropriate delivery in the corresponding data transmission mode, and the researcher being provided with a corresponding suitable consumer address. Moreover, the electronic data delivery mode from the retailer to the researcher may be different to the mode from the researcher to the consumer.

Although functions of the researcher computer system have been illustrated together in the figures, different aspects of the researcher computer system and implementations of the required functionality may be provided by geographically disparate components, which may or may not be operated by the same entity. For example, redirection email addresses could be generated at one location by one or more computers operated by one or more first entities, forwarded to one or more second computers operated by one or more second entities for storage, and routed to retailer computer systems using one or more third computers.

The embodiments have largely focussed on the actions of a researcher entity, a consumer entity, and a retailer entity, in association and as carried out using corresponding computer systems. Clearly, however, these embodiments are intended for use with a plurality of such consumers, for example a panel of consumers including hundreds or thousands of people, and may be applied to the purchases of such consumers online at a plurality of different retailers.

What is claimed is:

1. A method for operating a researcher computer system to obtain data identifying purchases made online by a consumer having a consumer email address, the method comprising:
providing a redirection email address for provision to a retailer computer system in place of the consumer email address, the researcher computer system being the addressee of emails sent to the redirection email address;
receiving a purchase record, sent from the retailer computer system to the redirection email address, the purchase record recording purchases made by the consumer online using the retailer computer system;
forwarding at least some of the content of the purchase record to the consumer email address for receipt by the consumer; and
extracting data relating to the purchases from the purchase record.

2. The method of claim 1 wherein providing a redirection email address for provision to a retailer computer system in place of the consumer email address comprises the researcher computer system generating the redirection email address.

3. The method of claim 1 wherein providing a redirection email address for provision to a retailer computer system in place of the consumer email address comprises the researcher computer system transmitting the redirection email address to the consumer.

4. The method of claim 1 wherein the redirection email address is unique to the consumer, or is unique to a particular consumer in combination with a particular retailer computer system.

5. The method of claim 1 wherein extracting data relating to the purchases from the purchase records comprises the researcher computer system parsing the purchase record.

6. The method of claim 1 further comprising:
receiving one or more further emails not comprising a purchase record, sent from the retailer computer system to the redirection email address;
extracting marketing activity data from the one or more further emails; and
forwarding the one or more further emails to the consumer email address for receipt by the consumer.

7. The method of claim 1 comprising providing a different redirection email address in respect of each of a plurality of said consumers, receiving purchase records in respect of a purchases made by each of said consumers, from one or more retailer computer systems, extracting data relating to the purchases from the purchase records, and combining the data to generate one or more reports.

8. The method of claim 1 further comprising:
the consumer receiving the redirection email address from the researcher computer system and forwarding the received redirection email address to the retailer computer system.

9. The method of claim 8 wherein, before forwarding the received redirection email address to the retailer computer system, the consumer forwards the consumer email address to the retail consumer system, such that subsequent forwarding of the received redirection email address to the retailer computer system replaces the consumer email address with the redirection email address at the retailer computer system.

10. The method of claim 8 further comprising the consumer using a consumer computer system to make said purchases over a network connection to the retailer computer system, the consumer computer system being an addressee of emails directed to said consumer email address.

11. The method of claim 1 further comprising the retailer computer system receiving the redirection email address in place of the consumer email address, generating said purchase record in response to on line purchases made by the consumer, and emailing the purchase record to the redirection email address.

12. A method of monitoring online consumer purchases by providing a redirection email address to an online retailer in substitution of a consumer email address, receiving purchase information from the online retailer at the redirection email address for analysis, and forwarding the purchase information to the consumer email address.

13. The method of claim 12 wherein the redirection email address and the consumer email addresses have different domain parts.

14. A researcher computer system for automatically obtaining data identifying purchases made online by a customer having a consumer email address, the computer system being arranged to:
provide a redirection email address for provision to a retailer computer system in substitution for the consumer email address, the researcher computer system being the addressee of emails sent to the redirection email address;
receive a purchase record, sent from the retailer computer system to the redirection email address, the purchase record recording purchases made by the consumer online using the retailer computer system;
forward at least some of the content of the purchase record to the consumer email address for receipt by the consumer; and
extract data relating to the purchases from the purchase record.

15. The researcher computer system of claim 14 further comprising an email address generator for generating the redirection email address for provision to the retailer computer system.

16. The researcher computer system of claim 15 wherein the email address generator generates the redirection email address to include a user name part based at least in part on a user name part of the consumer email address, and to include a domain part different to the domain part of the redirection email address.

17. The researcher computer system of claim 14 further comprising a researcher computer system graphical user interface (GUI) for presentation on a web browser of the consumer to permit registration of the consumer with the researcher computer system.

18. The researcher computer system of claim 17 wherein the researcher computer system GUI is arranged to receive from the consumer the consumer email address and to provide to the consumer the redirection email address.

19. The researcher computer system of claim 14 comprising an analysis component adapted to combine the said data extracted from a plurality of said purchase records.

20. A computer readable medium comprising computer program code arranged to carry out the following steps when executed on a researcher computer system connectable by a network to a retailer computer system and a consumer:
provide a redirection email address for provision to the retailer computer system in substitution for a consumer email address of the consumer, the researcher computer system being the addressee of the redirection email address;
receive a purchase record, sent from the retailer computer system to the redirection email address, the purchase record recording purchases made by the consumer online using the retailer computer system;
forward at least some of the content of the purchase record to the consumer email address for receipt by the consumer; and
extract data relating to the purchases from the purchase record.
